(19) United States
(12) Patent Application Publication
(10) Pub. No.: US 2015/0142658 A1
(43) Pub. Date: May 21, 2015

(54) PAYMENT BINDING MANAGEMENT METHOD, PAYMENT SERVER, CLIENT, AND SYSTEM

(71) Applicant: Tencent Technology (Shenzhen) Company Limited, Shenzhen (CN)

(72) Inventor: Jianli LI, Shenzhen (CN)

(21) Appl. No.: 14/458,122

(22) Filed: Aug. 12, 2014

Related U.S. Application Data
(63) Continuation of application No. PCT/CN2014/079644, filed on Jun. 11, 2014.

(30) Foreign Application Priority Data
Nov. 19, 2013 (CN) 201310586668.4

(51) Int. Cl. G06Q 20/40; G06Q 20/08

(52) U.S. Cl. CPC G06Q 20/401; G06Q 20/085
USPC 705/44

(57) ABSTRACT

A computer server receives a payment binding change request submitted by a client application from a requesting terminal, where the payment binding change request carries a payment account and terminal identification information of a target payment-bound terminal. If the target payment-bound terminal is registered as a secondary payment-bound terminal of the payment account, the computer server sends verification information to the target payment-bound terminal and returns prompt information to the client application. The prompt information is used to prompt a user of the client application to input and return the verification information sent to the target payment-bound terminal. If the verification information returned by the client application matches the verification information sent to the target payment-bound terminal, the computer server sets the target payment-bound terminal as a primary payment-bound terminal of the payment account.

### RELATED APPLICATIONS

This application is a continuation application of PCT Patent Application No. PCT/CN2014/079644, entitled “PAYMENT BINDING MANAGEMENT METHOD, PAYMENT SERVER, CLIENT, AND SYSTEM” filed on Jun. 11, 2014, which claims priority to Chinese Patent Application No. 201310586668.4, entitled “PAYMENT BINDING MANAGEMENT METHOD, PAYMENT SERVER, CLIENT, AND SYSTEM,” filed Nov. 19, 2013, both of which are incorporated by reference in their entirety.

### TECHNICAL FIELD

The present application relates to the field of Internet technologies, and in particular, to a payment binding management method, a payment server, a client, and a system.

### BACKGROUND

Most of current online payment solutions depend on security of terminal devices such as a mobile phone. Normally, a third-party payment account is bound to a mobile phone number of a user. When the user requests payment, a payment server sends a short message verification code to a mobile phone terminal of the user. After the user reads the short message verification code from the mobile phone terminal and inputs correctly and submits the short message verification code by using a payment client or a payment web page, the payment server checks the verification code, and performs a real payment operation only after the checking succeeds. If the mobile phone of the user is lost, online payment may have a huge security risk. Although most online payment solutions further check a payment password in addition to checking the short message verification code, the payment password of the user is also insecure when the mobile phone of the user is lost. A main reason is that current mainstream payment solutions all provide a function of retrieving the payment password by using a short message verification code of the user. Therefore, once the mobile phone of the user is lost, two defenses, namely the payment password and the short message verification code, are both very likely at risk of being ruined completely.

### SUMMARY

The above deficiencies and other problems (e.g., security issues) associated with the conventional approach of making online payment are reduced or eliminated by the present application disclosed below. In some embodiments, the present application is implemented in a computer server that has one or more processors, memory and one or more modules, programs or sets of instructions stored in the memory for performing multiple functions and communicating with a client device (e.g., smartphone) that has one or more processors, memory and one or more modules, programs or sets of instructions stored in the memory for performing multiple functions. Instructions for performing these functions may be included in a computer program product configured for execution by one or more processors.

One aspect of the present application involves a method for managing multiple payment-bound terminals at a computer server having one or more processors and memory storing program modules to be executed by the one or more processors. The computer server receives a payment binding change request submitted by a client application from a requesting terminal, where the payment binding change request carries a payment account and terminal identification information of a target payment-bound terminal. If the target payment-bound terminal is registered as a secondary payment-bound terminal of the payment account, the computer server sends verification information to the target payment-bound terminal and returns prompt information to the client application. The prompt information is used to prompt a user of the client application to input and return the verification information sent to the target payment-bound terminal. If the verification information returned by the client application matches the verification information sent to the target payment-bound terminal, the computer server sets the target payment-bound terminal as a primary payment-bound terminal of the payment account.

Another aspect of the present application involves a computer server including one or more processors, memory, one or more program modules stored in the memory and to be executed by the one or more processors. The program modules further include instructions for: receiving a payment binding change request submitted by a client application from a requesting terminal, where the payment binding change request carries a payment account and terminal identification information of a target payment-bound terminal; determining that the target payment-bound terminal is a secondary payment-bound terminal of the payment account according to the terminal identification information of the target payment-bound terminal; sending verification information to the target payment-bound terminal according to the terminal identification information of the target payment-bound terminal and returning prompt information to the client application, where the prompt information is used to prompt a user of the client application to input the verification information and return the verification information to the server; receiving the verification information returned by the client application in response to the prompt information and comparing the verification information returned by the client application with the verification information sent to the target payment-bound terminal; and in accordance with a determination that the verification information returned by the client application matches the verification information sent to the target payment-bound terminal, setting the target payment-bound terminal as a primary payment-bound terminal of the payment account.

Another aspect of the present application involves a non-transitory computer readable storage medium stores one or more program modules in connection with a computer server having one or more processors, the program modules including instructions for execution by one or more processors. The instructions, when executed by the one or more processors, cause the computer server to perform operations including: receiving a payment binding change request submitted by a client application from a requesting terminal, where the payment binding change request carries a payment account and terminal identification information of a target payment-bound terminal; determining that the target payment-bound terminal is a secondary payment-bound terminal of the payment account according to the terminal identification information of the target payment-bound terminal; sending verification information to the target payment-bound terminal according to the terminal identification information of the target payment-bound terminal and returning prompt information to the client application, where the prompt information is used to prompt a user of the client application to input the verification information and return the verification information to the server; receiving the verification information returned by the client application in response to the prompt information and comparing the verification information returned by the client application with the verification information sent to the target payment-bound terminal; and in accordance with a determination that the verification information returned by the client application matches the verification information sent to the target payment-bound terminal, setting the target payment-bound terminal as a primary payment-bound terminal of the payment account.

Various advantages of the present application are apparent in light of the descriptions below.

### BRIEF DESCRIPTION OF THE DRAWINGS

The aforementioned features and advantages of the present application as well as additional features and advantages thereof will be more clearly understood hereinafter as a result of a detailed description of preferred embodiments when taken in conjunction with the drawings.

To describe the technical solutions according to the embodiments of the present application or in the prior art more clearly, the accompanying drawings for describing the embodiments or the prior art are introduced briefly in the following. Apparently, the accompanying drawings in the following description are only some embodiments of the present application, and persons of ordinary skill in the art can derive other drawings from the accompanying drawings without creative efforts.

FIG. 1 is a schematic flowchart of a payment binding management method according to an embodiment of the present application;

FIG. 2 is a schematic view of an interface used by a user terminal, where a client is, to prompt a user to input verification information in a verification information input area according to an embodiment of the present application;

FIG. 3 is a schematic flowchart of a payment binding management method according to another embodiment of the present application;

FIG. 4 is a schematic flowchart of a payment binding management method according to another embodiment of the present application;

FIG. 5 is a schematic flowchart of a payment binding management method according to another embodiment of the present application;

FIG. 6 is a schematic structural view of a payment server according to an embodiment of the present application;

FIG. 7 is a schematic structural view of a payment server according to another embodiment of the present application;

FIG. 8 is a schematic structural view of a client according to an embodiment of the present application;

FIG. 9 is a schematic structural view of a user terminal, where a client is, according to an embodiment of the present application;

FIG. 10 is a schematic structural view of a payment binding management system according to an embodiment of the present application; and

FIG. 11 is a schematic structural view of a payment binding management system according to another embodiment of the present application.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The technical solution of the present application will be clearly and completely described in the following with reference to the accompanying drawings. It is obvious that the embodiments to be described are only a part rather than all of the embodiments of the present application. All other embodiments obtained by persons of ordinary skill in the art based on the embodiments of the present application without creative efforts shall fall within the protection scope of the present application.

A client in the embodiments of the present application may be an application software process run in a user terminal, such as an instant messaging client, a social networking services (SNS) client and an Internet payment client. The client application may log in to a corresponding payment server by using a login account input by a user, so as to perform payment binding management. The user terminal may include a client-side device such as a personal computer, a smartphone (such as an Android mobile phone and an iOS mobile phone), a tablet computer, a handheld computer, a mobile client-side device (MID), or a wearable smart device.

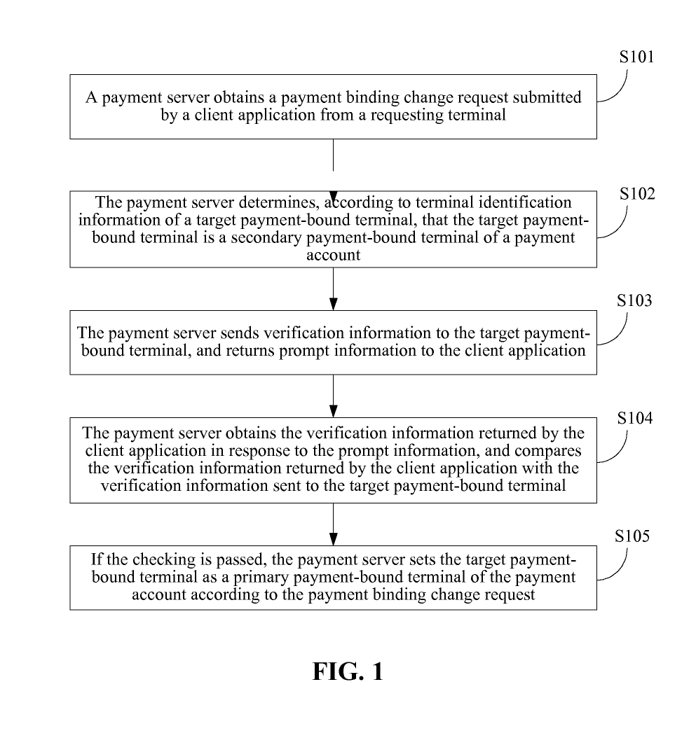

FIG. 1 is a schematic flowchart of a payment binding management method according to an embodiment of the present application. The payment binding management method described in FIG. 1 is described mainly on one side, namely a payment server. As shown in FIG. 1, the payment binding management method may include the following steps:

S101: A payment server obtains a payment binding change request submitted by a client application from a requesting terminal, where the payment binding change request carries a payment account and terminal identification information of a target payment-bound terminal.

In specific implementation, the terminal identification information of the target payment-bound terminal may include a mobile directory number (MDN) number, an international mobile equipment identification number (IMEI), a mobile subscriber identification number (MSIN), or other identification information that can represent identity information of the terminal device, for example an apple ID. The client application may be run in the target payment-bound terminal, and may also be independent of the target payment-bound terminal and run in a first user terminal, where the first user terminal may be another client-side device, for example a personal computer. The terminal identification information of the target payment-bound terminal may be input by a user, and when the client application is run in the target payment-bound terminal, the terminal identification information may also be obtained by reading firmware information of the target payment-bound terminal. The payment account is an account, designated by the user of the client application, for payment, such as a bank account for payment, an Alipay account, and a Tenpay account. In an alternative embodiment, a login account of the client application may be the same as the payment account.

S102: The payment server determines, according to the terminal identification information of the target payment-bound terminal, that the target payment-bound terminal is a secondary payment-bound terminal of the payment account.

In specific implementation, the payment server may set the target payment-bound terminal as a secondary payment-bound terminal of the payment account in advance according to a request of the client application. For example, a payment-bound terminals list is created for the payment account, and records terminal identification information of all user terminals having an established binding relationship with the payment account; one of the payment-bound terminals is a current primary payment-bound terminal, and the other payment-bound terminals are secondary payment-bound terminals; when the payment server receives a payment request submitted by the client application and regarding the payment account, the payment server sends verification information only to the primary payment-bound terminal of the payment account to perform payment verification. After receiving the payment binding change request submitted by the client application, the payment server first determines, according to the terminal identification information of the target payment-bound terminal, whether the target payment-bound terminal is a secondary payment-bound terminal of the payment account; if yes, executes the following Step S103; otherwise, may return error prompt information to the client application.

S103: The payment server sends verification information to the target payment-bound terminal according to the terminal identification information of the target payment-bound terminal, and returns prompt information to the client application, where the prompt information is used to prompt the user of the client application to input the verification information.

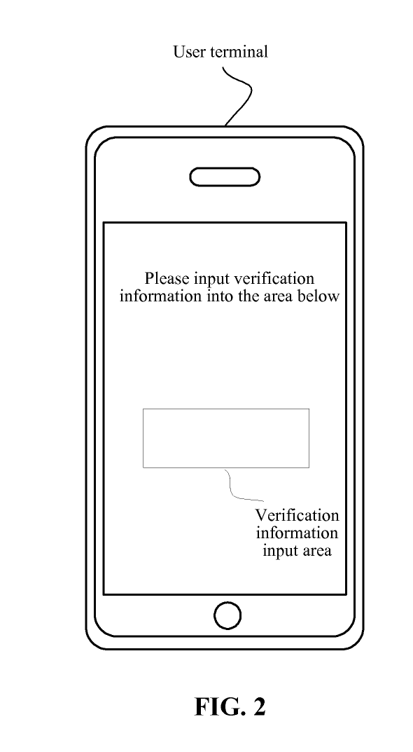

Specifically, the payment server may send the verification information to the target payment-bound terminal directly according to the terminal identification information of the target payment-bound terminal, and for example, the terminal identification information is an MDN number or information including the MDN number, so that the payment server may send the verification information, by using a short message or a multimedia message, to the target payment-bound terminal through the MDN number; in an alternative embodiment, the payment server may also obtain contact information of the target payment-bound terminal according to correspondence between the terminal identification information of the target payment-bound terminal and the contact information, so as to send the verification information to the target payment-bound terminal by using the obtained contact information, where the correspondence between the terminal identification information and the contact information may be obtained by using an available algorithm for mapping information, and the correspondence between the two may also be stored in advance in the payment server, so as to achieve better confidentiality of personal information. FIG. 2 is a schematic view of an interface used by the user terminal, where the client application is, to prompt the user to input the verification information in a verification information input area according to the embodiment of the present application, and the verification information may be a piece of text information or simple graphic information, for example, several digits or characters or symbols.

S104: The payment server obtains the verification information returned by the client application in response to the prompt information, and compares the verification information returned by the client application with the verification information sent to the target payment-bound terminal.

In specific implementation, the user of the client application may view the verification information, sent by the payment server, on the target payment-bound terminal, and input the verification information into the client application, so that the client application may send the verification information to the payment server in response to the prompt information accordingly. After receiving the verification information returned by the client application, the payment server checks the verification information returned by the client application and the verification information sent before by the payment server to the target payment-bound terminal, for example, to check whether they are consistent; if yes, the comparison is passed, and S105 is executed; otherwise, error prompt information may be returned to the client application.

S105: If the comparison is passed (e.g., the verification information returned by the client application matches the verification information sent to the target payment-bound terminal), the payment server sets the target payment-bound terminal as the primary payment-bound terminal of the payment account according to the payment binding change request.

Specifically, the payment server may delete a current primary payment-bound terminal of the payment account, and then set the terminal identification information of the target payment-bound terminal as the primary payment-bound terminal of the payment account, so as to set the target payment-bound terminal as the primary payment-bound terminal of the payment account. After the setting succeeds, the payment server may send a notification message to the client application, to notify that the binding relationship is changed, and verification information for payment will be sent to the target payment-bound terminal during a next payment.

In an alternative embodiment, in the method shown in FIG. 1, the payment server may first execute the following steps before executing Step S101.

11) The payment server obtains an adding payment-bound terminal request submitted by the client application, where the adding payment-bound terminal request carries the payment account and the terminal identification information of the target payment-bound terminal.

12) The payment server obtains terminal identification information of the then-primary payment-bound terminal of the payment account.

13) The payment server sends verification information to the then-primary payment-bound terminal according to the terminal identification information of the then-primary payment-bound terminal, and returns prompt information to the client application, where the prompt information is used to prompt the user of the client application to input the verification information and return the verification information to the server.

14) The payment server obtains the verification information returned by the client application in response to the prompt information, and compares the verification information returned by the client application with the verification information sent to the then-primary payment-bound terminal.

15) If the comparison is passed (e.g., the second verification information returned by the client application matches the second verification information sent to the then-primary payment-bound terminal), the payment server adds the target payment-bound terminal as a secondary payment-bound terminal of the payment account according to the adding payment-bound terminal request. Therefore optionally, before adding the target payment-bound terminal as a secondary payment-bound terminal of the payment account according to the adding payment-bound terminal request, the payment server may further determine first whether the payment account currently has a primary payment-bound terminal; if the payment account currently has a primary payment-bound terminal, set the target payment-bound terminal as a secondary payment-bound terminal of the payment account; otherwise, set the target payment-bound terminal as the primary payment-bound terminal of the payment account.

Through Steps 11) to 15), the payment server sets the target payment-bound terminal as the secondary payment-bound terminal of the payment account, so as to rapidly set the target payment-bound terminal as the primary payment-bound terminal of the payment account when needed later.

It can be seen that the payment binding management method described in FIG. 1 can set a secondary payment-bound terminal, designated by a user, as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

In some embodiments, a user may proactively replace a primary payment-bound terminal with a secondary payment-bound terminal temporarily for security reasons. For example, a user may register two mobile phones as payment-bound terminals with his/her bank account. A first mobile phone is for domestic use and registered as the primary payment-bound terminal while a second one is for international use and registered as the secondary payment-bound terminal. When the user travels abroad, he/she may carry only the second mobile phone and leaves the first one at home. In this case, the user may temporarily replace the first mobile phone with the second mobile phone as the primary payment-bound terminal and then reverse their binding relationship with the payment account after returns home. In this case, the user may log into his/her payment account to change the binding relationship or take the actions as described above in connection with FIG. 1.

In some other embodiments, the user may accidentally lose one of his/her secondary payment-bound terminals. In order to protect the user from adverse actions initiated from a lost secondary payment-bound terminal, the user has to be promptly notified of such events. This is especially important if the user does not carry the lost secondary payment-bound terminal all the time. In this case, after receiving the payment binding change request, the server sends an alert message to the then-primary (i.e., current) payment-bound terminal. Upon receipt of the alert message, the current payment-bound terminal generates a display like the one shown in FIG. 2. But instead of prompting the user to input the verification information the server sends to the lost secondary payment-bound terminal, the user is prompted to enter and return a password to the server within a predefined time window (e.g., 3-10 minutes). In some embodiments, the server holds off sending the verification information to the secondary payment-bound terminal until after the time window. This time window, along with the alert message, is used for giving the legitimate user of the current payment-bound terminal to respond. For example, if the user can enter and return the password from the current payment-bound terminal to the server within the predefined time window and the password matches a predefined password associated with the payment account, the server may deem that the payment binding change request was initiated by a malicious user and should be denied. In order to protect the legitimate user, the alert message may also display the terminal identification information of the target payment-bound terminal so that the user can take further actions to remove the lost secondary payment-bound terminal from the payment-bound terminals list associated with the payment account. If the password returned by the current payment-bound terminal is not within the predefined time window or if the password does not the predefined password associated with the payment account, the server then assumes that the user who possesses the current payment-bound terminal may be questionable. In this case, the server will proceed with answering the payment binding change request as described above in connection with FIGS. 1 and 2 above. Note that the password may be a user-defined alphanumerical string or an answer to a user-defined security question. Regardless, the password is unrelated to making payment using the then-primary payment-bound terminal.

Note that the requesting terminal and the target payment-bound terminal may be the same or different. For example, the requesting terminal may be a personal computer and the target payment-bound terminal is a mobile phone.

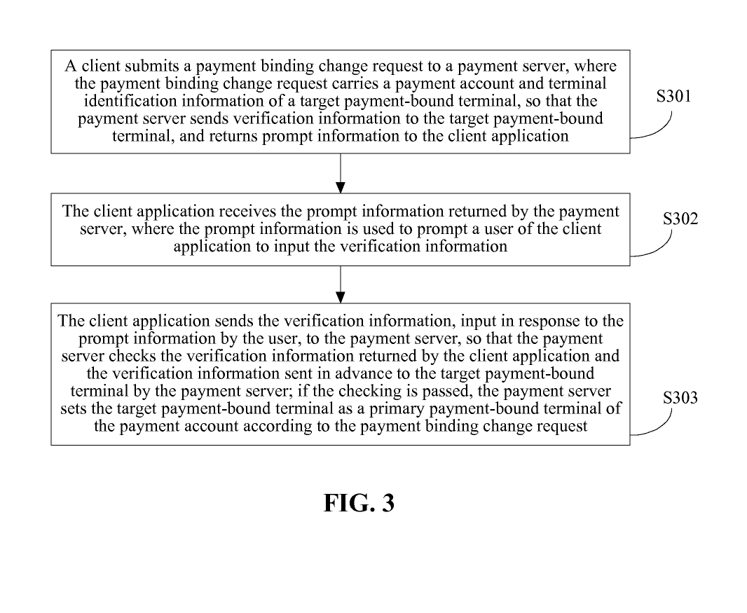

FIG. 3 is a schematic flowchart of a payment binding management method according to another embodiment of the present application, and the payment binding management method described in this embodiment is described mainly on one side, namely a client. As shown in FIG. 3, the payment binding management method may include the following steps:

S301: A client submits a payment binding change request to a payment server, where the payment binding change request carries a payment account and terminal identification information of a target payment-bound terminal, so that the payment server sends verification information to the target payment-bound terminal according to the terminal identification information of the target payment-bound terminal, and returns prompt information to the client application.

S302: The client application receives the prompt information returned by the payment server, where the prompt information is used to prompt a user of the client application to input the verification information and return the verification information to the server. FIG. 2 is a schematic view of an interface used by the user terminal, where the client application is, to prompt the user to input the verification information in a verification information input area according to the embodiment of the present application, and the verification information may be a piece of text information or simple graphic information, for example, several digits or characters or symbols.

S303: The client application sends the verification information, input in response to the prompt information by the user, to the payment server, so that the payment server checks the verification information returned by the client application and the verification information sent in advance to the target payment-bound terminal by the payment server; if the comparison is passed, the payment server sets the target payment-bound terminal as a primary payment-bound terminal of the payment account according to the payment binding change request.

In an alternative embodiment, in the method shown in FIG. 3, the client application may first execute the following steps before executing Step S301.

21) The client application submits an adding payment-bound terminal request to the payment server, where the adding payment-bound terminal request carries the payment account and the terminal identification information of the target payment-bound terminal, so that the payment server sends verification information to the primary payment-bound terminal of the payment account, and returns prompt information to the client application.

22) The client application receives the prompt information returned by the payment server, where the prompt information is used to prompt the user of the client application to input the verification information.

23) The client application sends the verification information, input in response to the prompt information by the user, to the payment server, so that the payment server checks the verification information returned by the client application and the verification information sent in advance to the primary payment-bound terminal by the payment server; if the comparison is passed, the payment server adds the target payment-bound terminal as a secondary payment-bound terminal of the payment account according to the adding payment-bound terminal request. Therefore optionally, before adding the target payment-bound terminal as a secondary payment-bound terminal of the payment account according to the adding payment-bound terminal request, the payment server may further determine first whether the payment account currently has a primary payment-bound terminal; if the payment account currently has a primary payment-bound terminal, set the target payment-bound terminal as a secondary payment-bound terminal of the payment account; otherwise, set the target payment-bound terminal as the primary payment-bound terminal of the payment account.

Through Steps 21) to 23), the client application requests the payment server to set the target payment-bound terminal as the secondary payment-bound terminal of the payment account, so as to rapidly set the target payment-bound terminal as the primary payment-bound terminal of the payment account when needed later.

It can be seen that the payment binding management method described in FIG. 3 can set a secondary payment-bound terminal, designated by a user, as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

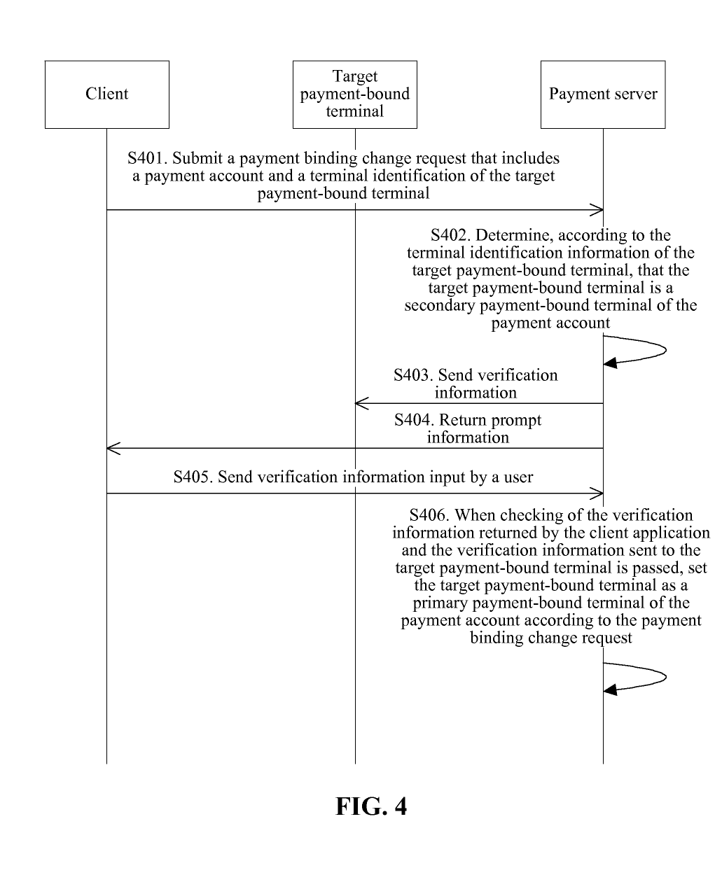

FIG. 4 is a schematic flowchart of a payment binding management method according to another embodiment of the present application, and a secure payment method described in this embodiment is described mainly on two sides, namely a user terminal and a payment server. As shown in FIG. 4, the secure payment method may include the following steps:

S401: A client submits a payment binding change request to a payment server, where the payment binding change request carries a payment account and terminal identification information of a target payment-bound terminal.

S402: The payment server determines, according to the terminal identification information of the target payment-bound terminal, that the target payment-bound terminal is a secondary payment-bound terminal of the payment account.

S403: The payment server sends verification information to the target payment-bound terminal according to the terminal identification information of the target payment-bound terminal.

S404: The payment server returns prompt information to the client application, where the prompt information is used to prompt a user of the client application to input the verification information and return the verification information to the server.

S405: The client application sends the verification information, input in response to the prompt information by the user, to the payment server.

S406: The payment server checks the verification information returned by the client application and the verification information sent in advance to the target payment-bound terminal by the payment server, and if the comparison is passed, sets the target payment-bound terminal as a primary payment-bound terminal of the payment account according to the payment binding change request.

It can be seen that the payment binding management method described in FIG. 4 can set a secondary payment-bound terminal, designated by a user, as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

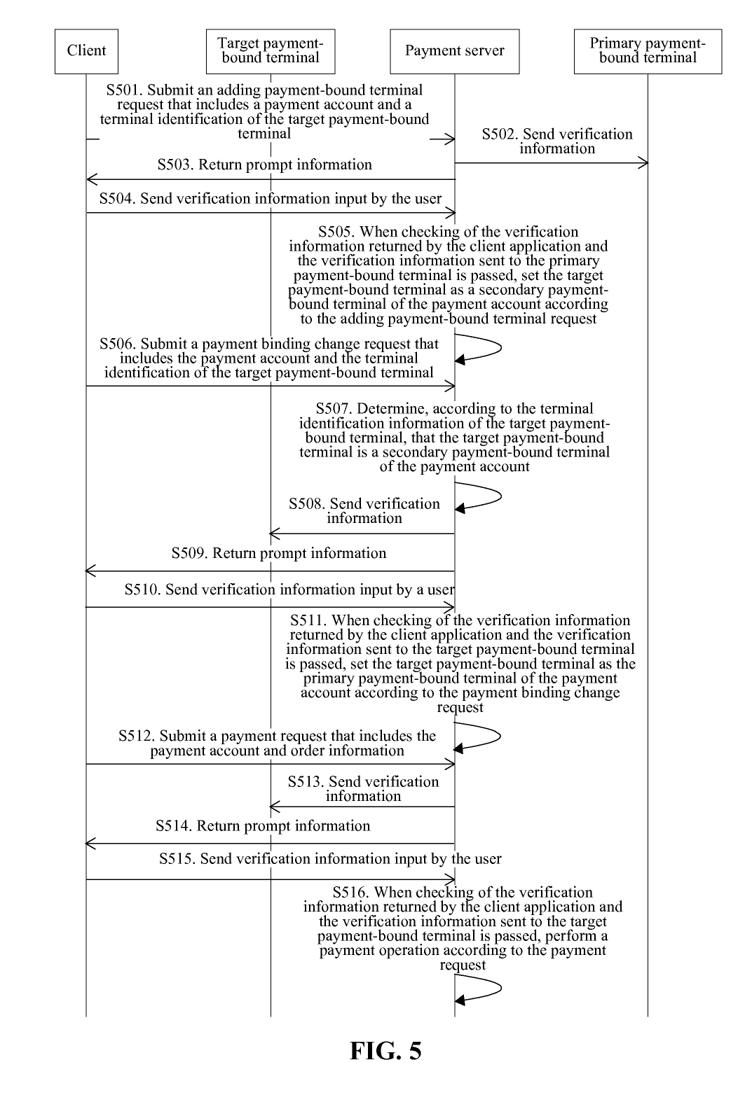

FIG. 5 is a schematic flowchart of a payment binding management method according to another embodiment of the present application, and a secure payment method described in this embodiment is described mainly on two sides, namely a user terminal and a payment server. As shown in FIG. 5, the secure payment method may include the following steps:

S501: A client submits an adding payment-bound terminal request to a payment server, where the adding payment-bound terminal request carries a payment account and terminal identification information of a target payment-bound terminal.

S502: The payment server sends verification information to a primary payment-bound terminal of the payment account.

In specific implementation, the payment server may obtain terminal identification information of the primary payment-bound terminal of the payment account, so as to send the verification information to the primary payment-bound terminal of the payment account according to the terminal identification information.

S503: The payment server returns prompt information to the client application, where the prompt information is used to prompt a user of the client application to input the verification information and return the verification information to the server.

S504: The client application sends the verification information, input in response to the prompt information by the user, to the payment server.

S505: The payment server compares the verification information returned by the client application with the verification information sent to the primary payment-bound terminal, and if the comparison is passed, adds the target payment-bound terminal as a secondary payment-bound terminal of the payment account according to the adding payment-bound terminal request. Therefore optionally, before adding the target payment-bound terminal as a secondary payment-bound terminal of the payment account according to the adding payment-bound terminal request, the payment server may further determine first whether the payment account currently has a primary payment-bound terminal; if the payment account currently has a primary payment-bound terminal, set the target payment-bound terminal as a secondary payment-bound terminal of the payment account; otherwise, set the target payment-bound terminal as the primary payment-bound terminal of the payment account.

S506: The client application submits a payment binding change request to the payment server, where the payment binding change request carries the payment account and the terminal identification information of the target payment-bound terminal.

S507: The payment server determines, according to the terminal identification information of the target payment-bound terminal, that the target payment-bound terminal is a secondary payment-bound terminal of the payment account.

S508: The payment server sends verification information to the target payment-bound terminal according to the terminal identification information of the target payment-bound terminal.

S509: The payment server returns prompt information to the client application, where the prompt information is used to prompt the user of the client application to input the verification information.

S510: The client application sends the verification information, input in response to the prompt information by the user, to the payment server.

S511: The payment server checks the verification information returned by the client application and the verification information sent in advance to the target payment-bound terminal by the payment server, and if the comparison is passed, sets the target payment-bound terminal as the primary payment-bound terminal of the payment account according to the payment binding change request.

S512: The client application submits a payment request to the payment server, where the payment request includes the payment account and order information.

S513: The payment server sends verification information to the primary payment-bound terminal of the payment account.

In specific implementation, the payment server may obtain terminal identification information of the primary payment-bound terminal of the payment account, so as to send the verification information to the primary payment-bound terminal of the payment account according to the terminal identification information. In this embodiment, the primary payment-bound terminal of the payment account is the target payment-bound terminal.

S514: The payment server returns prompt information to the client application, where the prompt information is used to prompt the user of the client application to input the verification information.

S515: The client application sends the verification information to the payment server in response to the prompt information.

S516: The payment server compares the verification information returned by the client application with the verification information sent to the primary payment-bound terminal, and if the comparison is passed, the payment server performs a payment operation according to the payment request.

It can be seen that the payment binding management method described in FIG. 5 can set a secondary payment-bound terminal, designated by a user, as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

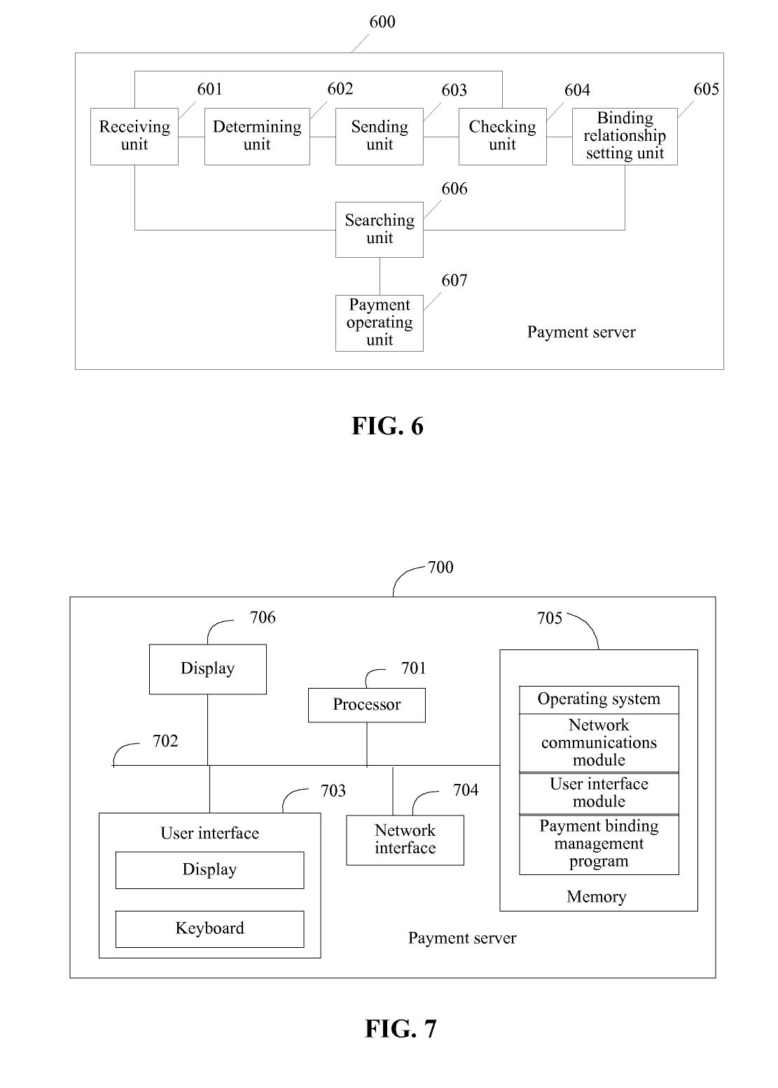

FIG. 6 is a schematic structural view of a payment server according to an embodiment of the present application, and as shown in FIG. 6, a payment server 600 of this embodiment may at least include: a receiving unit 601, a determining unit 602, and a sending unit 603.

The receiving unit 601 is configured to obtain a payment binding change request submitted by a client application from a requesting terminal, where the payment binding change request carries a payment account and terminal identification information of a target payment-bound terminal.

In specific implementation, the terminal identification information of the target payment-bound terminal may include a mobile directory number (MDN) number, an international mobile equipment identification number (IMEI), a mobile subscriber identification number (MSIN), or other identification information that can represent identity information of the terminal device, for example an apple ID. The client application may be run in the target payment-bound terminal, and may also be independent of the target payment-bound terminal and run in a first user terminal, where the first user terminal may be another client-side device, for example a personal computer. The terminal identification information of the target payment-bound terminal may be input by a user, and when the client application is run in the target payment-bound terminal, the terminal identification information may also be obtained by reading firmware information of the target payment-bound terminal. The payment account is an account, designated by the user of the client application, for payment, such as a bank account for payment, an Alipay account, and a Tenpay account. In an alternative embodiment, a login account of the client application may be the same as the payment account.

The determining unit 602 is configured to determine, according to the terminal identification information of the target payment-bound terminal, whether the target payment-bound terminal is a secondary payment-bound terminal of the payment account.

In specific implementation, the payment server may set the target payment-bound terminal as a secondary payment-bound terminal of the payment account in advance according to a request of the client application. For example, a payment-bound terminals list is created for the payment account, and records terminal identification information of all user terminals having an established binding relationship with the payment account; one of the payment-bound terminals is a current primary payment-bound terminal, and the other payment-bound terminals are secondary payment-bound terminals; when the payment server receives a payment request submitted by the client application and regarding the payment account, the payment server sends verification information only to the primary payment-bound terminal of the payment account to perform payment verification. After the receiving unit 601 receives the payment binding change request submitted by the client application, the determining unit 602 determines, according to the terminal identification information of the target payment-bound terminal, whether the target payment-bound terminal is a secondary payment-bound terminal of the payment account; if yes, triggers the sending unit 603 to send verification information to the target payment-bound terminal; otherwise, may trigger the sending unit 603 to return error prompt information to the client application.

The sending unit 603 is configured to: when a determination result of the determining unit 602 is yes, send the verification information to the target payment-bound terminal according to the terminal identification information of the target payment-bound terminal, and return prompt information to the client application, where the prompt information is used to prompt the user of the client application to input the verification information.

Specifically, the sending unit 603 may send the verification information to the target payment-bound terminal directly according to the terminal identification information of the target payment-bound terminal, and for example, the terminal identification information is an MDN number or information including the MDN number, so that the sending unit 603 may send the verification information, by using a short message or a multimedia message, to the target payment-bound terminal through the MDN number; in an alternative embodiment, the sending unit 603 may also obtain contact information of the target payment-bound terminal according to correspondence between the terminal identification information of the target payment-bound terminal and the contact information, so as to send the verification information to the target payment-bound terminal by using the obtained contact information, where the correspondence between the terminal identification information and the contact information may be obtained by using an available algorithm for mapping information, and the correspondence between the two may also be stored in advance in the payment server, so as to achieve better confidentiality of personal information. FIG. 2 is a schematic view of an interface used by the user terminal, where the client application is, to prompt the user to input the verification information in a verification information input area according to the embodiment of the present application, and the verification information may be a piece of text information or simple graphic information, for example, several digits or characters or symbols.

The receiving unit 601 is further configured to obtain the verification information sent in response to the prompt information by the client application.

In specific implementation, the user of the client application may view the verification information, sent by the payment server, on the target payment-bound terminal, and input the verification information into the client application, so that the client application may send the verification information to the payment server in response to the prompt information accordingly.

The payment server further includes: a checking unit 604, configured to check the verification information returned by the client application and the verification information sent to the target payment-bound terminal by the sending unit 603, for example, so as to check whether they are consistent, where if they are consistent, the comparison is passed; and if the checking is not passed, the checking unit 604 may further trigger the sending unit 603 to return error prompt information to the client application; and a binding relationship setting unit 605, configured to: when the checking by the checking unit 604 is successful, set the target payment-bound terminal as the primary payment-bound terminal of the payment account according to the payment binding change request.

Specifically, the binding relationship setting unit 605 may delete a current primary payment-bound terminal of the payment account, and then set the terminal identification information of the target payment-bound terminal as the primary payment-bound terminal of the payment account, so as to set the target payment-bound terminal as the primary payment-bound terminal of the payment account. After the setting succeeds, the binding relationship setting unit 605 may further trigger the sending unit 603 to send a notification message to the client application, to notify that the binding relationship is changed, and verification information for payment will be sent to the target payment-bound terminal during a next payment.

In an alternative embodiment, before obtaining the payment binding change request submitted by the user, the receiving unit 601 may be further configured to obtain an adding payment-bound terminal request submitted by the client application, where the adding payment-bound terminal request carries the payment account and the terminal identification information of the target payment-bound terminal.

Correspondingly, the payment server further includes: a searching unit 606, configured to obtain terminal identification information of the primary payment-bound terminal of the payment account.

Correspondingly, the sending unit 603 is further configured to send verification information to the primary payment-bound terminal according to the terminal identification information of the primary payment-bound terminal, and return prompt information to the client application, where the prompt information is used to prompt the user of the client application to input the verification information.

The receiving unit 601 is further configured to obtain the verification information sent in response to the prompt information by the client application.

The checking unit 604 is further configured to check the verification information returned by the client application and the verification information sent to the primary payment-bound terminal by the sending unit 603.

The binding relationship setting unit 605 is further configured to: when the checking by the checking unit 604 is successful, set the target payment-bound terminal as a secondary payment-bound terminal of the payment account according to the adding payment-bound terminal request. Therefore optionally, before adding the target payment-bound terminal as a secondary payment-bound terminal of the payment account according to the adding payment-bound terminal request, the binding relationship setting unit 605 may further determine first whether the payment account currently has a primary payment-bound terminal; if the payment account currently has a primary payment-bound terminal, set the target payment-bound terminal as a secondary payment-bound terminal of the payment account; otherwise, set the target payment-bound terminal as the primary payment-bound terminal of the payment account.

In an alternative embodiment, the receiving unit 601 is further configured to obtain a payment request submitted by the client application, where the payment request includes the payment account and order information.

Correspondingly, the payment server further includes: a searching unit 606, configured to obtain terminal identification information of the primary payment-bound terminal of the payment account.

The sending unit 603 is further configured to send verification information to the primary payment-bound terminal of the payment account according to the terminal identification information, and return prompt information to the client application, where the prompt information is used to prompt the user of the client application to input the verification information.

The receiving unit 601 is further configured to obtain the verification information sent in response to the prompt information by the client application.

The checking unit 604 is further configured to check the verification information returned by the client application and the verification information sent to the primary payment-bound terminal by the sending unit.

The payment server further includes: a payment operating unit 607, configured to perform a payment operation according to the payment request when the checking by the checking unit is successful.

It can be seen that, by using the payment server 600 shown in FIG. 6, a secondary payment-bound terminal designated by a user can be set as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

FIG. 7 is a schematic structural view of a payment server according to another embodiment of the present application, and as shown in FIG. 7, a payment server 700 of this embodiment may include: at least one processor 701, for example a central processing unit (CPU), at least one network interface 704, a user interface 703, a memory 705, and at least one communication bus 702. The communication bus 702 is configured to implement connection communication between the components. The user interface 703 may include a display and a keyboard, and optionally, the user interface 703 may further include a standard wired interface and a standard wireless interface. Optionally, the network interface 704 may include a standard wired interface and a standard wireless interface (for example, a WI-FI interface). The memory 705 may be a high-speed random access memory (RAM) memory, and may also be a non-transitory computer readable storage medium, for example at least one magnetic disk memory. Optionally, the memory 705 may also be at least one storage apparatus away from the processor 701. As shown in FIG. 7, as a computer storage medium, the memory 705 may include an operating system, a network communications module, a user interface module, and a payment binding management program. The operation of the payment binding management program has been described above in connection with FIGS. 1-5.

In the payment server 700 shown in FIG. 7, the network interface 704 is mainly configured to connect to a user terminal, and perform data communication with the user terminal or a client in the user terminal; the processor 701 may be configured to call the payment binding management program stored in the memory 705 and execute the following operations: using the network interface 704 to obtain a payment binding change request submitted by a client application from a requesting terminal, where the payment binding change request carries a payment account and terminal identification information of a target payment-bound terminal; determining, according to the terminal identification information of the target payment-bound terminal, whether the target payment-bound terminal is a secondary payment-bound terminal of the payment account; if yes, using the network interface 704 to send verification information to the target payment-bound terminal according to the terminal identification information of the target payment-bound terminal, and return prompt information to the client application, where the prompt information is used to prompt a user of the client application to input the verification information and return the verification information to the server; using the network interface 704 to obtain the verification information returned by the client application in response to the prompt information, and comparing the verification information returned by the client application with the verification information sent to the target payment-bound terminal; and if the comparison is passed (e.g., the verification information returned by the client application matches the verification information sent to the target payment-bound terminal), setting the target payment-bound terminal as a primary payment-bound terminal of the payment account according to the payment binding change request, where optionally, before the setting the target payment-bound terminal as a primary payment-bound terminal of the payment account according to the payment binding change request, a current primary payment-bound terminal of the payment account may be deleted first.

Therefore, in an alternative embodiment, if it is determined, according to the terminal identification information of the target payment-bound terminal, that the target payment-bound terminal is not a secondary payment-bound terminal of the payment account, or the checking by the payment server fails, error prompt information is returned to the client application by using the network interface 704.

In an embodiment, the processor 701 may further execute the following operations by calling the payment binding management program stored in the memory 705: using the network interface 704 to obtain an adding payment-bound terminal request submitted by the client application, where the adding payment-bound terminal request carries the payment account and the terminal identification information of the target payment-bound terminal; obtaining terminal identification information of the primary payment-bound terminal of the payment account; using the network interface 704 to send verification information to the primary payment-bound terminal according to the terminal identification information of the primary payment-bound terminal, and return prompt information to the client application, where the prompt information is used to prompt the user of the client application to input the verification information; and using the network interface 704 to obtain the verification information returned by the client application in response to the prompt information, and check the verification information returned by the client application and the verification information sent to the primary payment-bound terminal, and if the comparison is passed, adding the target payment-bound terminal as a secondary payment-bound terminal of the payment account according to the adding payment-bound terminal request. Therefore optionally, before the adding the target payment-bound terminal as a secondary payment-bound terminal of the payment account according to the adding payment-bound terminal request, it may be further determined first whether the payment account currently has a primary payment-bound terminal; if the payment account currently has a primary payment-bound terminal, the target payment-bound terminal is set as a secondary payment-bound terminal of the payment account; otherwise, the target payment-bound terminal may be set as the primary payment-bound terminal of the payment account.

In an embodiment, the processor 701 may further execute the following operations by calling the payment binding management program stored in the memory 705: using the network interface 704 to obtain a payment request submitted by the client application, where the payment request includes a payment account and order information; obtaining terminal identification information of the primary payment-bound terminal of the payment account; using the network interface 704 to send verification information to the primary payment-bound terminal of the payment account according to the terminal identification information, and return prompt information to the client application, where the prompt information is used to prompt the user of the client application to input the verification information; and using the network interface 704 to obtain the verification information returned by the client application in response to the prompt information, and check the verification information returned by the client application and the verification information sent to the primary payment-bound terminal; if the comparison is passed, performing a payment operation according to the payment request.

It can be seen that, by using the payment server 700 shown in FIG. 7, a secondary payment-bound terminal designated by a user can be set as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

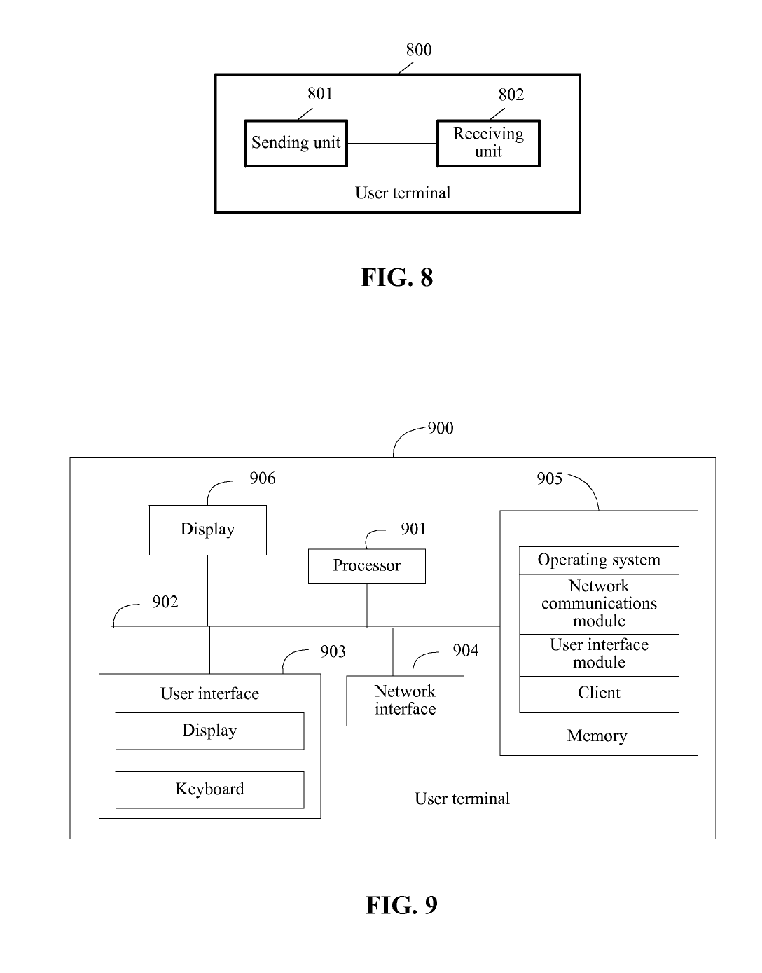

FIG. 8 is a schematic structural view of a client according to an embodiment of the present application. The client application in the embodiment of the present application may be an application software process run in a user terminal, such as an SNS client and an Internet payment client. The client application may log in to a corresponding payment server by using a login account input by a user, so as to perform payment binding management. The user terminal may include a client-side device such as a personal computer, a smartphone (such as an Android mobile phone and an iOS mobile phone), a tablet computer, a handheld computer, a mobile client-side device (MID), or a wearable smart device. As shown in FIG. 8, the client application of this embodiment may at least include: a sending unit 801 and a receiving unit 802.

The sending unit 801 is configured to submit a payment binding change request to a payment server, where the payment binding change request carries a payment account and terminal identification information of a target payment-bound terminal, so that the payment server sends verification information to the target payment-bound terminal according to the terminal identification information of the target payment-bound terminal, and returns prompt information to a client.

In specific implementation, the terminal identification information of the target payment-bound terminal may include a mobile directory number (MDN) number, an international mobile equipment identification number (IMEI), a mobile subscriber identification number (MSIN), or other identification information that can represent identity information of the terminal device, for example an apple ID. The client application may be run in the target payment-bound terminal, and may also be independent of the target payment-bound terminal and run in a first user terminal, where the first user terminal may be another client-side device, for example a personal computer. The terminal identification information of the target payment-bound terminal may be input by a user, and when the client application is run in the target payment-bound terminal, the terminal identification information may also be obtained by reading firmware information of the target payment-bound terminal. The payment account is an account, designated by the user of the client application, for payment, such as a bank account for payment, an Alipay account, and a Tenpay account. In an alternative embodiment, a login account of the client application may be the same as the payment account.

The receiving unit 802 is configured to receive the prompt information returned by the payment server, where the prompt information is used to prompt the user of the client application to input the verification information.

The sending unit 801 is further configured to send the verification information, input in response to the prompt information by the user, to the payment server, so that the payment server checks the verification information returned by the client application and the verification information sent in advance to the target payment-bound terminal by the payment server; if the comparison is passed, the payment server sets the target payment-bound terminal as a primary payment-bound terminal of the payment account according to the payment binding change request.

In an alternative embodiment, before submitting the payment binding change request to the payment server, the sending unit 801 is further configured to submit an adding payment-bound terminal request to the payment server, where the adding payment-bound terminal request carries the payment account and the terminal identification information of the target payment-bound terminal, so that the payment server sends verification information to the primary payment-bound terminal of the payment account, and returns prompt information to the client application.

Correspondingly, the receiving unit 802 is further configured to receive the prompt information returned by the payment server, where the prompt information is used to prompt the user of the client application to input the verification information.

The sending unit 801 is further configured to send the verification information, input in response to the prompt information by the user, to the payment server, so that the payment server checks the verification information returned by the client application and the verification information sent in advance to the primary payment-bound terminal by the payment server; if the comparison is passed, the payment server adds the target payment-bound terminal as a secondary payment-bound terminal of the payment account according to the adding payment-bound terminal request.

It can be seen that, by using the client application 800 shown in FIG. 8, a payment server may be request to set a secondary payment-bound terminal, designated by a user, as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

FIG. 9 is a schematic structural view of a user terminal, where a client is, according to an embodiment of the present application, and as shown in FIG. 9, a user terminal 900 may include: at least one processor 901, for example a CPU, at least one network interface 904, a user interface 903, a memory 905, at least one communication bus 902, and a display 906. The communication bus 902 is configured to implement connection communication between the components. The user interface 903 may include a display and a keyboard, and optionally, the user interface 903 may further include a standard wired interface and a standard wireless interface. Optionally, the network interface 904 may include a standard wired interface and a standard wireless interface (for example, a WI-FI interface). The memory 905 may be a high-speed RAM memory, and may also be a non-transitory computer readable storage medium, for example at least one magnetic disk memory. Optionally, the memory 905 may also be at least one storage apparatus away from the processor 901. As shown in FIG. 9, as a computer storage medium, the memory 905 may include an operating system, a network communications module, a user interface module, and the client application described in the foregoing description with reference to FIG. 8.

In the user terminal 900 shown in FIG. 9, the network interface 904 is mainly configured to connect to a payment server, and perform data communication with the payment server; the processor 901 may be configured to call the client application stored in the memory 905, and execute the following operations: using the network interface 904 to submit a payment binding change request to a payment server, where the payment binding change request carries a payment account and terminal identification information of a target payment-bound terminal, so that the payment server sends verification information to the target payment-bound terminal according to the terminal identification information of the target payment-bound terminal, and returns prompt information to a client application; using the network interface 904 to receive the prompt information returned by the payment server, where the prompt information is used to prompt a user of the client application to input the verification information and return the verification information to the server; and using the network interface 904 to send the verification information, input in response to the prompt information by the user, to the payment server, so that the payment server checks the verification information returned by the client application and the verification information sent in advance to the target payment-bound terminal by the payment server; if the comparison is passed, the payment server sets the target payment-bound terminal as a primary payment-bound terminal of the payment account according to the payment binding change request.

In an embodiment, the processor 901 may further execute the following operations by calling the client application stored in the memory 905: using the network interface 904 to submit an adding payment-bound terminal request to the payment server, where the adding payment-bound terminal request carries the payment account and the terminal identification information of the target payment-bound terminal, so that the payment server sends verification information to the primary payment-bound terminal of the payment account, and returns prompt information to the client application; using the network interface 904 to receive the prompt information returned by the payment server, where the prompt information is used to prompt the user of the client application to input the verification information; and using the network interface 904 to send the verification information, input in response to the prompt information by the user, to the payment server, so that the payment server checks the verification information returned by the client application and the verification information sent in advance to the primary payment-bound terminal by the payment server; if the comparison is passed, the payment server adds the target payment-bound terminal as a secondary payment-bound terminal of the payment account according to the adding payment-bound terminal request.

It should be noted that, the user terminal 900 of this embodiment may be the target payment-bound terminal, and may also be a first user terminal independent of the target payment-bound terminal, where the first user terminal may be another client-side device, for example a personal computer.

It can be seen that, by using the user terminal 900 shown in FIG. 9, a payment server may be request to set a secondary payment-bound terminal, designated by a user, as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

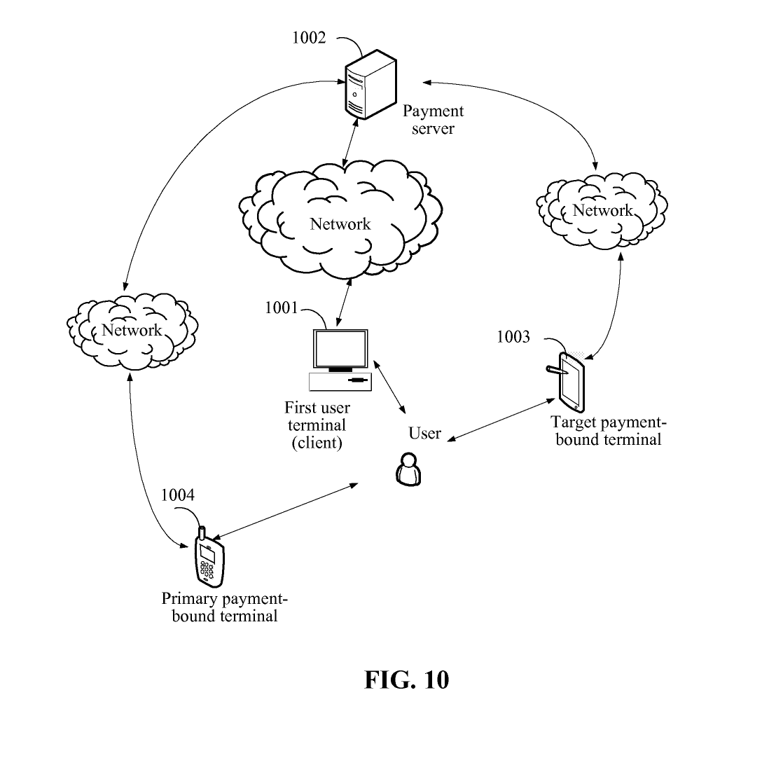

FIG. 10 is a schematic structural view of a payment binding management system according to an embodiment of the present application, and as shown in FIG. 10, the payment binding management system may include a first user terminal 1001, a payment server 1002, and a target payment-bound terminal 1003, where the first user terminal 1001 and the target payment-bound terminal 1003 may be connected to the payment server 1002 by a network, the first user terminal 1001 may be the user terminal introduced in the foregoing description with reference to FIG. 9, and the client application shown in FIG. 8 is run in the first user terminal 1001, so that in this embodiment, the first user terminal 1001 is used to represent the client application, and the payment server 1002 may be the payment server introduced in the foregoing description with reference to FIG. 6 or FIG. 7.

The first user terminal 1001 is configured to submit a payment binding change request to the payment server 1002, where the payment binding change request carries a payment account and terminal identification information of the target payment-bound terminal.

The payment server 1002 is configured to obtain the payment binding change request, determine, according to the terminal identification information of the target payment-bound terminal, whether the target payment-bound terminal 1003 is a secondary payment-bound terminal of the payment account, and if yes, send verification information to the target payment-bound terminal 1003 according to the terminal identification information of the target payment-bound terminal, and return prompt information to the first user terminal 1001, where the prompt information is used to prompt a user of the first user terminal 1001 to input the verification information.

The first user terminal 1001 is further configured to send the verification information, input in response to the prompt information by the user, to the payment server.

The payment server 1002 is further configured to check the verification information sent by the first user terminal 1001 and the verification information sent in advance to the target payment-bound terminal 1003 by the payment server, and if the comparison is passed, set the target payment-bound terminal 1003 as a primary payment-bound terminal of the payment account according to the payment binding change request.

In an alternative embodiment, the payment binding management system may further include a current primary payment-bound terminal 1004 of the payment account. Before submitting the payment binding change request to the payment server 1002, the first user terminal 1001 is further configured to submit an adding payment-bound terminal request to the payment server 1002, where the adding payment-bound terminal request carries the payment account and the terminal identification information of the target payment-bound terminal.

Correspondingly, the payment server 1002 is further configured to obtain the adding payment-bound terminal request submitted by the first user terminal 1001, send verification information to the primary payment-bound terminal 1004 of the payment account, and return prompt information to the first user terminal 1001, where the prompt information is used to prompt the user of the first user terminal 1001 to input the verification information.

The first user terminal 1001 is further configured to receive the prompt information returned by the payment server 1002, and send the verification information, input in response to the prompt information by the user, to the payment server 1002.

The payment server 1002 is further configured to obtain the verification information sent in response to the prompt information by the first user terminal 1001, check the verification information sent by the first user terminal 1001 and the verification information sent by the primary payment-bound terminal 1004 of the payment account, and if the comparison is passed, set the target payment-bound terminal 1003 as a secondary payment-bound terminal of the payment account according to the adding payment-bound terminal request.

In an alternative embodiment, the payment server 1002 is further configured to return error prompt information to the first user terminal 1001 when it is determined, according to the terminal identification information of the target payment-bound terminal, that the target payment-bound terminal is not a secondary payment-bound terminal of the payment account or when the checking fails.

It can be seen that, by using the payment binding management system shown in FIG. 10, a secondary payment-bound terminal designated by a user can be set as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

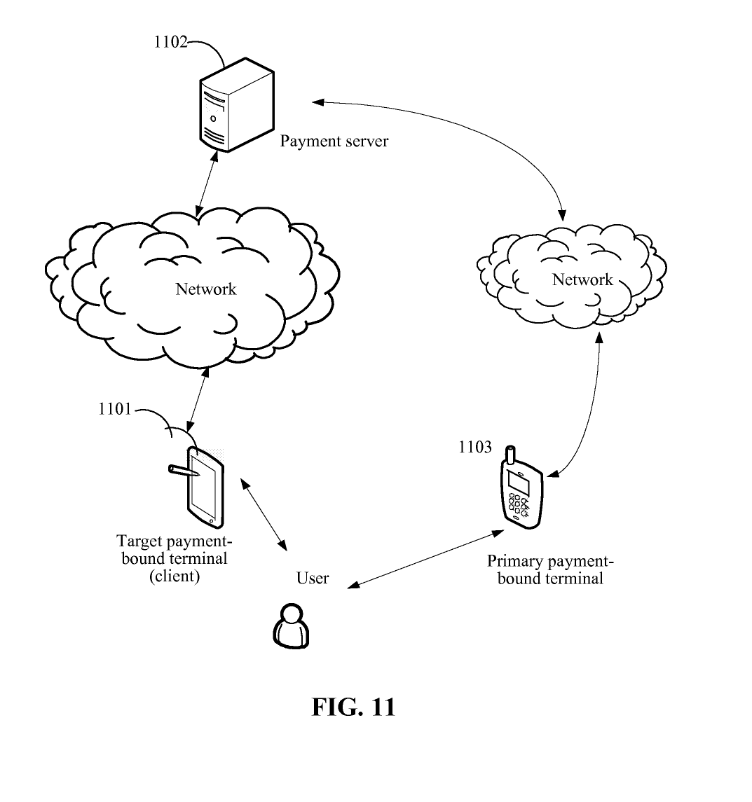

FIG. 11 is a schematic structural view of a payment binding management system according to another embodiment of the present application, and as shown in the drawing, the payment binding management system of this embodiment may include a target payment-bound terminal 1101 and a payment server 1102, where the target payment-bound terminal 1101 may be connected to the payment server 1102 by a network; the target payment-bound terminal 1101 may be the user terminal introduced in the foregoing description with reference to FIG. 9, and the client application shown in FIG. 8 is run in the target payment-bound terminal 1101; the payment server 1102 may be the payment server introduced in the foregoing description with reference to FIG. 6 or FIG. 7. Specifically:

The client application is configured to submit a payment binding change request to the payment server 1102, where the payment binding change request carries a payment account and terminal identification information of the target payment-bound terminal.

The payment server 1102 is configured to obtain the payment binding change request, determine, according to the terminal identification information of the target payment-bound terminal, whether the target payment-bound terminal 1101 is a secondary payment-bound terminal of the payment account, and if yes, send verification information to the target payment-bound terminal 1101 according to the terminal identification information of the target payment-bound terminal, and return prompt information to the client application, where the prompt information is used to prompt a user of the client application to input the verification information and return the verification information to the server.

The client application is further configured to send the verification information, input in response to the prompt information by the user, to the payment server.

The payment server 1102 is further configured to check the verification information returned by the client application and the verification information sent in advance to the target payment-bound terminal 1101 by the payment server, and if the comparison is passed, set the target payment-bound terminal 1101 as a primary payment-bound terminal of the payment account according to the payment binding change request.

In an alternative embodiment, the payment binding management system may further include a current primary payment-bound terminal 1103 of the payment account.

Before submitting the payment binding change request to the payment server 1102, the client application is further configured to submit an adding payment-bound terminal request to the payment server 1102, where the adding payment-bound terminal request carries the payment account and the terminal identification information of the target payment-bound terminal.

Correspondingly, the payment server 1102 is further configured to obtain the adding payment-bound terminal request submitted by the client application, send verification information to the primary payment-bound terminal 1103 of the payment account, and return prompt information to the client application, where the prompt information is used to prompt the user of the client application to input the verification information.

The client application is further configured to receive the prompt information returned by the payment server 1102, and send the verification information, input in response to the prompt information by the user, to the payment server 1102.

The payment server 1102 is further configured to obtain the verification information returned by the client application in response to the prompt information, and check the verification information returned by the client application and the verification information sent to the primary payment-bound terminal 1103, and if the comparison is passed, set the target payment-bound terminal 1101 as a secondary payment-bound terminal of the payment account according to the adding payment-bound terminal request.

In an alternative embodiment, the payment server 1102 is further configured to return error prompt information to the client application when it is determined, according to the terminal identification information of the target payment-bound terminal, that the target payment-bound terminal is not a secondary payment-bound terminal of the payment account or when the checking fails.

It can be seen that, by using the payment binding management system shown in FIG. 11, a secondary payment-bound terminal designated by a user can be set as a primary payment-bound terminal of a payment account, so that when the primary payment-bound terminal of the user is accidentally lost, payment can be continued by rapidly switching to a secondary payment-bound terminal, so as to freeze a primary payment-bound terminal by replacing it with a secondary payment-bound terminal, and avoid freezing the payment account, thereby improving use security and continuity of the payment account.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the present application herein is for the purpose of describing particular embodiments only and is not intended to be limiting of the present application. As used in the description of the present application and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

What is claimed is:

1. A method for managing multiple payment-bound terminals, the method comprising:
at a server having one or more processors and memory storing program modules to be executed by the one or more processors:
receiving a payment binding change request submitted by a client application from a requesting terminal, where the payment binding change request carries a payment account and terminal identification information of a target payment-bound terminal;
determining that the target payment-bound terminal is a secondary payment-bound terminal of the payment account according to the terminal identification information of the target payment-bound terminal;
sending verification information to the target payment-bound terminal according to the terminal identification information of the target payment-bound terminal and returning prompt information to the client application, where the prompt information is used to prompt a user of the client application to input the verification information and return the verification information to the server;
receiving the verification information returned by the client application in response to the prompt information and comparing the verification information returned by the client application with the verification information sent to the target payment-bound terminal; and
in accordance with a determination that the verification information returned by the client application matches the verification information sent to the target payment-bound terminal, setting the target payment-bound terminal as a primary payment-bound terminal of the payment account.

2. The method of claim 1, further comprising:
before receiving the payment binding change request:
receiving an adding payment-bound terminal request submitted by the client application, where the adding payment-bound terminal request carries the payment account and the terminal identification information of the target payment-bound terminal;
obtaining terminal identification information of a then-primary payment-bound terminal of the payment account;
sending second verification information to the then-primary payment-bound terminal according to the terminal identification information of the then-primary payment-bound terminal, and returning prompt information to the client application, wherein the prompt information is used to prompt the user of the client application to input the second verification information and return the second verification information to the server;
receiving the second verification information returned by the client application and comparing the second verification information returned by the client application with the second verification information sent to the then-primary payment-bound terminal; and
in accordance with a determination that the second verification information returned by the client application matches the second verification information sent to the then-primary payment-bound terminal, adding the target payment-bound terminal as a secondary payment-bound terminal of the payment account.

3. The method of claim 1, further comprising:
after receiving the payment binding change request:
sending an alert message to a then-primary payment-bound terminal, wherein the alert message is used to prompt a return of a password by the then-primary payment-bound terminal within a predefined time window;
in accordance with a determination that the password returned by the then-primary payment-bound terminal is within the predefined time window and the password matches a predefined password associated with the payment account, denying the payment binding change request; and
in accordance with a determination that the password returned by the then-primary payment-bound terminal is not within the predefined time window or the password does not the predefined password associated with the payment account, sending the verification information to the target payment-bound terminal.

4. The method of claim 3, wherein the alert message includes the terminal identification information of the target payment-bound terminal.

5. The method of claim 3, wherein the password is an answer to a user-defined security question.

6. The method of claim 3, wherein the password is unrelated to making payment using the then-primary payment-bound terminal.

7. The method of claim 1, wherein the requesting terminal is different from the target payment-bound terminal.

8. The method of claim 7, wherein the requesting terminal is a personal computer and the target payment-bound terminal is a mobile phone.

9. The method of claim 1, wherein the requesting terminal is the target payment-bound terminal.

10. A computer server comprising:
one or more processors;
memory; and
one or more program modules stored in the memory and to be executed by the one or more processors, the program modules further including instructions for:
receiving a payment binding change request submitted by a client application from a requesting terminal, where the payment binding change request carries a payment account and terminal identification information of a target payment-bound terminal;
determining that the target payment-bound terminal is a secondary payment-bound terminal of the payment account according to the terminal identification information of the target payment-bound terminal;
sending verification information to the target payment-bound terminal according to the terminal identification information of the target payment-bound terminal and returning prompt information to the client application, where the prompt information is used to prompt a user of the client application to input the verification information and return the verification information to the server;
receiving the verification information returned by the client application in response to the prompt information and comparing the verification information returned by the client application with the verification information sent to the target payment-bound terminal; and
in accordance with a determination that the verification information returned by the client application matches the verification information sent to the target payment-bound terminal, setting the target payment-bound terminal as a primary payment-bound terminal of the payment account.

11. The computer server of claim 10, wherein the program modules further include instructions for:
before receiving the payment binding change request:
receiving an adding payment-bound terminal request submitted by the client application, where the adding payment-bound terminal request carries the payment account and the terminal identification information of the target payment-bound terminal;
obtaining terminal identification information of a then-primary payment-bound terminal of the payment account;
sending second verification information to the then-primary payment-bound terminal according to the terminal identification information of the then-primary payment-bound terminal, and returning prompt information to the client application, wherein the prompt information is used to prompt the user of the client application to input the second verification information and return the second verification information to the server;
receiving the second verification information returned by the client application and comparing the second verification information returned by the client application with the second verification information sent to the then-primary payment-bound terminal; and
in accordance with a determination that the second verification information returned by the client application matches the second verification information sent to the then-primary payment-bound terminal, adding the target payment-bound terminal as a secondary payment-bound terminal of the payment account.

12. The computer server of claim 10, wherein the program modules further include instructions for:
after receiving the payment binding change request:
sending an alert message to a then-primary payment-bound terminal, wherein the alert message is used to prompt a return of a password by the then-primary payment-bound terminal within a predefined time window;
in accordance with a determination that the password returned by the then-primary payment-bound terminal is within the predefined time window and the password matches a predefined password associated with the payment account, denying the payment binding change request; and
in accordance with a determination that the password returned by the then-primary payment-bound terminal is not within the predefined time window or the password does not the predefined password associated with the payment account, sending the verification information to the target payment-bound terminal.

13. The computer server of claim 12, wherein the alert message includes the terminal identification information of the target payment-bound terminal.

14. The computer server of claim 10, wherein the requesting terminal is different from the target payment-bound terminal.

15. The computer server of claim 10, wherein the requesting terminal is the target payment-bound terminal.

16. A non-transitory computer readable storage medium storing one or more program modules in connection with a computer server having one or more processors, the one or more program modules comprising instructions, which, when executed by the one or more processors, cause the computer server to perform operations comprising:
receiving a payment binding change request submitted by a client application from a requesting terminal, where the payment binding change request carries a payment account and terminal identification information of a target payment-bound terminal;
determining that the target payment-bound terminal is a secondary payment-bound terminal of the payment account according to the terminal identification information of the target payment-bound terminal;
sending verification information to the target payment-bound terminal according to the terminal identification information of the target payment-bound terminal and returning prompt information to the client application, where the prompt information is used to prompt a user of the client application to input the verification information and return the verification information to the server;
receiving the verification information returned by the client application in response to the prompt information and comparing the verification information returned by the client application with the verification information sent to the target payment-bound terminal; and
in accordance with a determination that the verification information returned by the client application matches the verification information sent to the target payment-bound terminal, setting the target payment-bound terminal as a primary payment-bound terminal of the payment account.

17. The non-transitory computer readable storage medium of claim 16, wherein the program modules further include instructions for:
before receiving the payment binding change request:
receiving an adding payment-bound terminal request submitted by the client application, where the adding payment-bound terminal request carries the payment account and the terminal identification information of the target payment-bound terminal;
obtaining terminal identification information of a then-primary payment-bound terminal of the payment account;
sending second verification information to the then-primary payment-bound terminal according to the terminal identification information of the then-primary payment-bound terminal, and returning prompt information to the client application, wherein the prompt information is used to prompt the user of the client application to input the second verification information and return the second verification information to the server;
receiving the second verification information returned by the client application and comparing the second verification information returned by the client application with the second verification information sent to the then-primary payment-bound terminal; and
in accordance with a determination that the second verification information returned by the client application matches the second verification information sent to the then-primary payment-bound terminal, adding the target payment-bound terminal as a secondary payment-bound terminal of the payment account.

18. The non-transitory computer readable storage medium of claim 16, wherein the program modules further include instructions for:
after receiving the payment binding change request:
sending an alert message to a then-primary payment-bound terminal, wherein the alert message is used to prompt a return of a password by the then-primary payment-bound terminal within a predefined time window;
in accordance with a determination that the password returned by the then-primary payment-bound terminal is within the predefined time window and the password matches a predefined password associated with the payment account, denying the payment binding change request; and
in accordance with a determination that the password returned by the then-primary payment-bound terminal is not within the predefined time window or the password does not the predefined password associated with the payment account, sending the verification information to the target payment-bound terminal.

19. The non-transitory computer readable storage medium of claim 16, wherein the requesting terminal is different from the target payment-bound terminal.

20. The non-transitory computer readable storage medium of claim 16, wherein the requesting terminal is the target payment-bound terminal.
